(19) United States
(12) Patent Application Publication
(10) Pub. No.: US 2009/0067037 A1
(43) Pub. Date: Mar. 12, 2009

(54) OPTICAL AMPLIFICATION APPARATUS AND OPTICAL COMMUNICATION APPARATUS

(75) Inventors: Daisuke HAYASHI, Otsu-shi (JP); Masayuki SUEHIRO, Musashino-shi (JP); Shinji IIO, Masashino-shi (JP); Naoaki MACHIDA, Musashino-shi (JP); Morio WADA, Musahino-shi (JP); Katsuya IKEZAWA, Musashino-shi (JP)

Correspondence Address: SUGHRUE MION, PLLC, 2100 PENNSYLVANIA AVENUE, N.W., SUITE 800, WASHINGTON, DC, 20037, US

(73) Assignee: YOKOGAWA ELECTRIC CORPORATION, Tokyo (JP)

(21) Appl. No.: 12/205,041

(22) Filed: Sep. 5, 2008

(30) Foreign Application Priority Data
Sep. 10, 2007 (JP) 2007-233887

(51) Int. Cl. H01S 3/00

(52) U.S. Cl. 359/333

(57) ABSTRACT

An optical amplification apparatus includes an optical amplification medium which has an input end and an output end, and amplifies an optical signal by a predetermined amplification rate; a first light source for launching excited light which excites the optical amplification medium; an isolator connected to the output end of the optical amplification medium; and a second light source for launching idle light which has a predetermined wavelength and is launched into the optical amplification medium from a point between the optical amplification medium and the isolator. The optical amplification medium, the first light source, the isolator, and the second light source are contained in the package of the optical amplification apparatus. The apparatus may further include a set of an optical absorption member for absorbing the idle light and an circulator connected to the input end of the optical amplification medium, or an input-side isolator connected to the input end of the optical amplification medium.

### BACKGROUND OF THE INVENTION

1. Field of the Invention

The present invention relates to an optical amplification apparatus and an optical communication apparatus which includes the optical amplification apparatus.

Priority is claimed on Japanese Patent Application No. 2007-233887, filed Sep. 10, 2007, the contents of which are incorporated herein by reference.

2. Description of the Related Art

In recent years, communications traffic has considerably increased in accordance with an increase in the penetration rate of optical fibers, and thus improvement in the communication efficiency has been required. As a technique for improving the communication efficiency, optical burst switching or optical packet switching has been watched, in which optical-signal switching is directly (i.e., optically) performed without converting each optical signal into an electrical signal. In such a technique, switching is performed using an optical burst or packet as a unit.

Generally, in an optical network, an optical amplification apparatus is provided for amplifying each optical signal, and so it is in an optical network which uses the above-described optical burst switching or the like. Generally, the optical amplification apparatus has an EDFA (erbium-doped fiber amplifier), and an optical signal passes through the EDFA so that the signal is amplified.

In an optical network using optical burst switching or the like, an optical signal is intermittently input into the EDFA, and overshooting (the optical signal is excessively amplified) occurs in the EDFA. Japanese Unexamined Patent Application, First Publication No. 2007-124472 discloses a technique in which continuous light (idle light), which has a wavelength different from that of the relevant optical signal, is always launched into the EDFA, so as to relax the overshooting. The disclosed technique will be briefly explained below.

FIG. 4 is a block diagram showing the general structure of a conventional optical amplification apparatus 100. As shown in FIG. 4, the optical amplification apparatus 100 has an EDFA 101, an idle-light LD (laser diode) 102, an optical isolator 103, and a wavelength filter 104, and amplifies a received optical signal S101 by a specific amplification rate, thereby outputting an optical signal S102.

The EDFA 101 has an EDF (erbium-doped (optical) fiber) 111 connected between an optical isolator 110 and an optical isolator 112, an excited-light LD 113 for exciting the EDF 111, and an isolator 114. These structural elements of the EDFA 101 are contained in a rectangular package having a size of approximately a few ten millimeters at each side.

The EDF 111 is excited by the excited-light LD 113. When an optical signal having a specific wavelength (e.g., within the C-band (1530 to 1565 nm)) is launched into the EDF 111, stimulated emission occurs in the EDF 111, which amplifies the optical signal.

In order to relax the above-described overshooting, the idle-light LD 102 always launches continuous light (i.e., idle light S103) which has a wavelength different from that of the optical signal S101. The wavelength filter removes the idle light S103 from the optical signal launched from the EDFA 101.

FIG. 5 is a diagram showing an example of the wavelengths of the optical signal S101 and the idle light S103, and the transmission characteristics (T100) of the wavelength filter 104. As shown in FIG. 5, the optical signal S101 includes a plurality of channels which have different wavelengths within the C-band. The idle light S103 has a wavelength which also belongs to the C-band, but differs from those of the channels included in the optical signal S101. Also as shown in FIG. 5, the transmission characteristics T100 of the wavelength filter 104 transmit all channels included in the optical signal S101, and do not transmit the idle light S103.

In the optical amplification apparatus 100 having the above-described structure, as the idle light S103 is always launched into the EDFA 101, stimulated emission occurs in the EDF 111, so that a certain amount of energy is always consumed. Therefore, even if no optical signal S101 is input, no excessive energy is stored in the EDF 111, thereby relaxing the above-described overshooting.

As described above, in the conventional optical amplification apparatus 100, the idle-light LD 102 and the isolator 103 are provided at the input side of the optical signal S101 for the EDFA 101, and the wavelength filter 104 is provided at the output side of the optical signal S101, so as to relax the overshooting. However, as the idle-light LD 102, the isolator 103, and the wavelength filter 104 need to be provided on the outside of the EDFA 101, the size of the apparatus must be increased.

In addition, the wavelength filter 104 should have transmission characteristics by which all channels of the input optical signal S101 are transmitted, and the idle light S103 is removed simultaneously. Therefore, within the wavelength range in which amplification in the EDFA 101 is possible, a specific range including the wavelength of the idle light S103 is blocked by the wavelength filter 104. Accordingly, the entire wavelength range with respect to the EDFA 101 is not effectively used. In this case, if the number of channels included in the optical signal S101 is increased in future, the wavelength filter 104 may restrict such an increase in the number of channels.

### SUMMARY OF THE INVENTION

In light of the above circumstances, an object of the present invention is to provide an optical amplification apparatus and an optical communication apparatus including the optical amplification apparatus, by which the wavelength range which can be used can be increased without increasing the size of the apparatus.

Therefore, the present invention provides an optical amplification apparatus (see reference numerals 1 and 2 in an embodiment (and a variation thereof) explained later) comprising:

an optical amplification medium (see reference numeral 12 in the embodiment) which has an input end and an output end, and amplifies an optical signal (see reference symbol S1 in the embodiment) by a predetermined amplification rate;

a first light source (see reference numeral 14 in the embodiment) for launching excited light (see reference symbol S3 in the embodiment) which excites the optical amplification medium;

an isolator (see reference numeral 13 in the embodiment) connected to the output end of the optical amplification medium; and

a second light source (see reference numeral 16 in the embodiment) for launching idle light (see reference symbol S4 in the embodiment) which has a predetermined wavelength and is launched into the optical amplification medium from a point between the optical amplification medium and the isolator, wherein:

the optical amplification medium, the first light source, the isolator, and the second light source are contained in the package of the optical amplification apparatus.

In accordance with the above structure, the optical amplification medium is excited by the excited light launched from the first light source, and simultaneously, energy stored in the optical amplification medium is always consumed by the idle light which is launched from the second light source, and is launched into the optical amplification medium from a point between the optical amplification medium and the isolator. When the optical signal is input under these conditions, no overshooting occurs, and the optical signal is amplified by the predetermined amplification rate.

In a typical example, the optical amplification apparatus may further comprises:

an optical absorption member (see reference numeral 18 in the embodiment) for absorbing the idle light; and

a circulator (see reference numeral 11 in the embodiment) connected to the input end of the optical amplification medium, wherein the circulator directs the optical signal to the input end of the optical amplification medium, and directs the idle light, which is launched from the input end of the optical amplification medium, to the optical absorption member, wherein:

the optical absorption member and the circulator are also contained in the package.

In another typical example, the optical amplification apparatus may further comprises:

an input-side isolator (see reference numeral 20 in the embodiment) which is connected to the input end of the optical amplification medium, and transmits the optical signal only in the direction toward the input end of the optical amplification medium, wherein:

the input-side isolator is also contained in the package.

In another typical example, the second light source launches light, which has a wavelength belonging to the wavelength range of the optical signal, as the idle light.

In a preferable example, the wavelength of the idle light launched from the second light source is variable.

In another typical example, the optical amplification medium is an erbium-doped optical fiber.

The present invention also provides an optical communication apparatus (see reference numerals 31, 32, and 33 in the embodiment) for intermittently transmitting, receiving, or relaying an optical signal, where the optical communication apparatus includes the optical amplification apparatus as described above, which amplifies the optical signal.

In accordance with the present invention, as the idle light launched from the second light source is launched into the optical amplification medium from a point between the optical amplification medium and the isolator, it is unnecessary to provide a wavelength filter (which is necessary in the conventional apparatus), thereby reducing the size of the relevant apparatus. In addition, as the first light source is also contained in the package of the apparatus, the size of the apparatus can be further reduced. Additionally, in the present invention which does not need the above-described wavelength filter, no wavelength range is blocked by such a wavelength filter, so that the wavelength range, which can be used in the relevant apparatus, can be widened.

### BRIEF DESCRIPTION OF THE DRAWINGS

FIG. 1 is a block diagram showing the general structure of an optical amplification apparatus as an embodiment of the present invention.

FIG. 2 is a block diagram showing the general structure of an optical amplification apparatus as a variation of the embodiment of the present invention.

FIG. 3 is a block diagram showing the general structure of an optical communication system.

FIG. 4 is a block diagram showing the general structure of a conventional optical amplification apparatus.

FIG. 5 is a diagram showing an example of the wavelengths of the optical signal S101 and the idle light S103, and the transmission characteristics of the wavelength filter.

### DETAILED DESCRIPTION OF THE INVENTION

Hereinafter, an optical amplification apparatus and an optical communication apparatus will be described as an embodiment of the present invention, with reference to the appended figures.

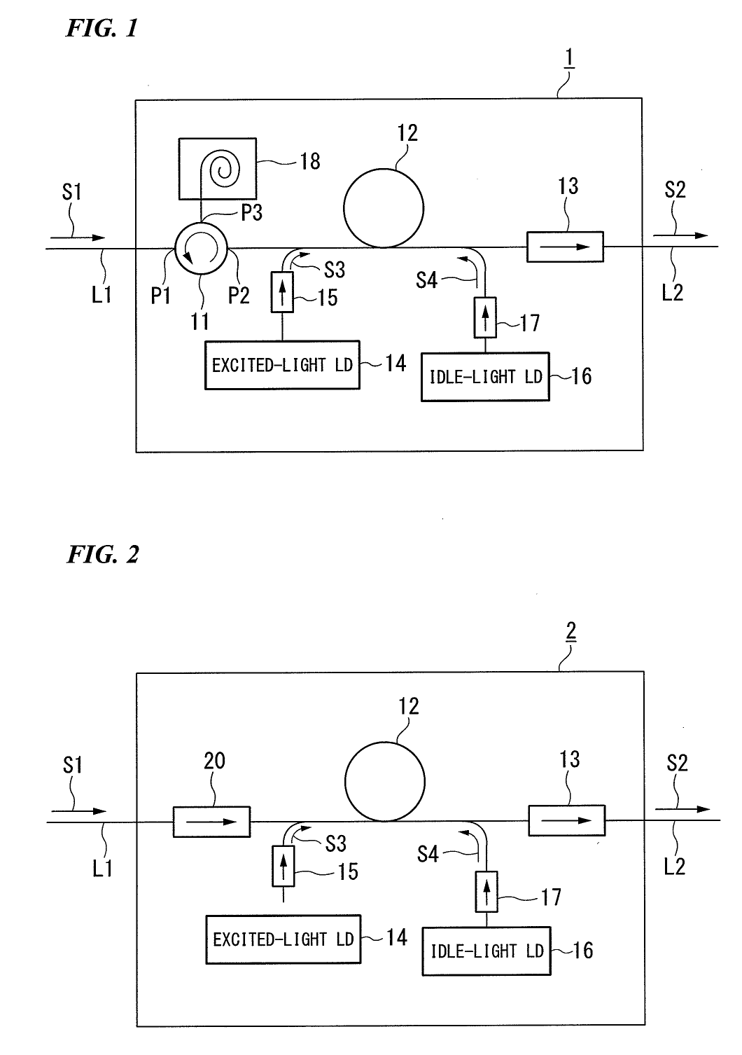

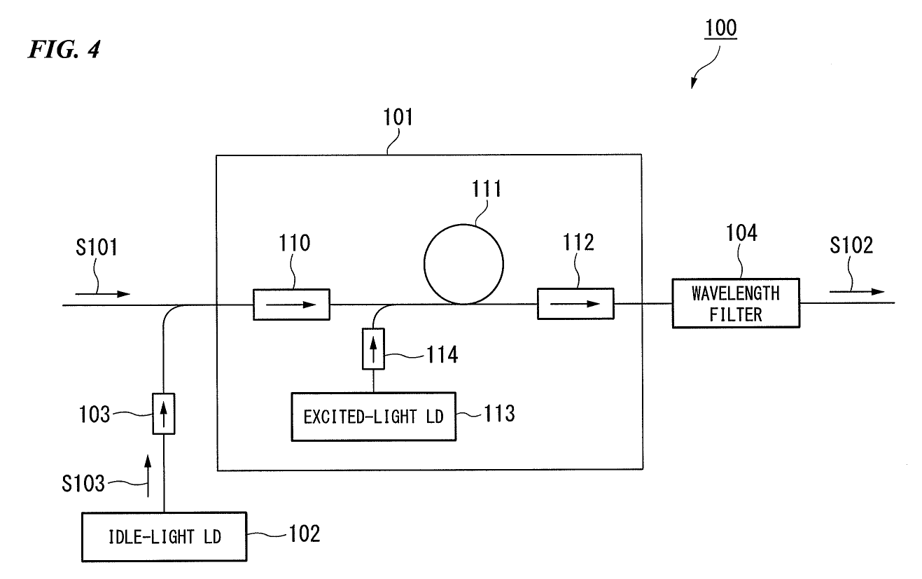

FIG. 1 is a block diagram showing the general structure of an optical amplification apparatus 1 as an embodiment of the present invention. As shown in FIG. 1, the optical amplification apparatus 1 has an optical circulator 11 (i.e., as the circulator of the present invention), an EDF (erbium-doped (optical) fiber) 12 (as the optical amplification medium of the present invention), an optical isolator 13 (as the isolator of the present invention), an excited-light LD (laser diode) 14 (i.e., as the first light source of the present invention), an optical isolator 15, an idle-light LD 16 (i.e., as the second light source of the present invention), an optical isolator 17, and an optical absorption member 18. These structural elements of the apparatus are contained in a rectangular package (not shown) having a size of approximately a few ten millimeters at each side. This size is almost identical to that of the package for containing the EDFA 101 in FIG. 4. The optical amplification apparatus 1 amplifies an optical signal S1, which is launched via an optical fiber L1, by a predetermined amplification rate, and outputs the amplified optical signal S2 via an optical fiber L2.

The optical circulator 11 has three input/output ports P1 to P3. The optical circulator 11 (i) outputs an optical signal input from the input/output port P1 to the input/output port P2, (ii) outputs an optical signal input from the input/output port P2 to the input/output port P3, and (iii) outputs an optical signal input from the input/output port P3 to the input/output port P1. The optical fiber L1 is connected to the input/output port P1, and an end (i.e., input end) of the EDF 12 is connected to the input/output port P2. In addition, the optical absorption member 18 is connected to the input/output port P3.

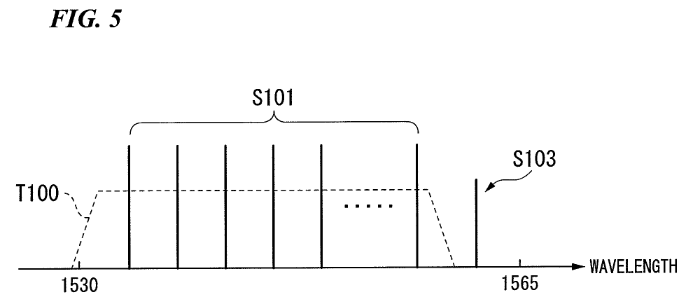

The EDF 12 is excited by the excited-light LD 14, and amplifies the input optical signal S1 (which is output from the input/output port P2 of the optical circulator 11) by a predetermined amplification rate. Similar to the optical signal S101 in FIG. 5, the optical signal S1 includes a plurality of channels having different wavelengths which may belong to the C-band (wavelength: 1530 to 1565 nm). When the optical signal S1 is launched into the EDF 12, stimulated emission occurs in the EDF 12, which amplifies the launched optical signal S1.

The input end of the optical isolator 13 is connected to the other end (i.e., output end) of the EDF 12, and the output end of the optical isolator 13 is connected to the optical fiber L2. The optical isolator 13 transmits the optical signal, which has been amplified by the EDF 12, and outputs the transmitted signal into the optical fiber L2. The optical isolator 13 also blocks an optical signal which is output from the optical fiber L2 toward the EDF 12. That is, the optical isolator 13 transmits only the optical signal which is output from the EDF 12 toward the optical fiber L2.

The excited-light LD 14 launches excited light S3 for exciting the EDF 12. The wavelength of the excited light S3 may be 980 or 1480 nm.

The optical isolator 15 (i) transmits the excited light S3 launched from the excited-light LD 14, so that the transmitted light S3 is launched into the EDF 12, and (ii) blocks light which travels from the EDF12 toward the excited-light LD 14. Accordingly, it is possible to prevent a variation in the power or wavelength of the excited light S3, which is launched from the excited-light LD 14.

The idle-light LD 16 launches continuous light (i.e., idle light S4) which has a predetermined wavelength, and is used for preventing overshooting of the optical signal S1, that is, preventing the optical signal S1 from being excessively amplified. The wavelength of the idle light S4 may be (i) a predetermined wavelength within the wavelength range in which the amplification through the EDF 12 is possible, (ii) a predetermined wavelength within the C-band, or (iii) a predetermined wavelength within the wavelength range of the optical signal S1. In addition, the wavelength of the idle light S4 may be identical to that of any channel included in the optical signal S1 which is launched via the optical fiber L1. Preferably, the idle-light LD 16 can vary the wavelength of the idle light S4.

The optical isolator 17 (i) transmits the idle light S4 launched from the idle-light LD 16, so that the transmitted light S4 is launched into the EDF 12 from a point between the EDF 12 and the optical isolator 13, and (ii) blocks light which travels from the EDF12 toward the idle-light LD 16. Accordingly, it is possible to prevent a variation in the power or wavelength of the idle light S4, which is launched from the idle-light LD 16.

The optical absorption member 18 absorbs the idle light S4, which is launched into the input/output port P2 of the optical circulator 11 via the EDF 12, and then launched from the input/output port P3 thereof. The optical absorption member 18 is provided for preventing the idle light S4 (launched form the idle-light LD 16) from being launched toward the outside of the optical amplification apparatus 1. If there is light which is incident from the optical absorption member 18 onto the input/output port P3, the light is launched from the input/output port P1, which may cause a noise. Therefore, preferably, the optical absorption member 18 has characteristics for also absorbing wavelengths other than the wavelength of the idle light S4. As the optical absorption member 18, an EDF (which is not excited) similar to the EDF 12 may be used.

In the above-described structure, during the operation of the optical amplification apparatus 1, the excited light S3 is launched from the excited-light LD 14, and simultaneously, the idle light S4 is launched from the idle-light LD 16. The excited light S3 from the excited-light LD 14 is transmitted through the optical isolator 15, and launched into the EDF 12 from a point between the optical circulator 11 and the EDF 12, that is, from the input end of the EDF 12. Accordingly, the EDF 12 is excited.

In contrast, the idle light S4 launched from the idle-light LD 16 is transmitted through the optical isolator 17, and launched into the EDF 12 from a point between the EDF 12 and the optical isolator 13, that is, from the output end of the EDF 12. Accordingly, in the EDF 12, stimulated emission occurs, and a certain level of energy is always consumed. Here, the idle light S4 launched into the EDF 12 is amplified due to the stimulated emission, and then launched into the input/output port P2 of the optical circulator 11, which is launched from the input/output port P3, so as to be absorbed by the optical absorption member 18. Therefore, no idle light S4 is launched toward the outside of the optical amplification apparatus 1.

When the optical signal S1 is launched into the optical amplification apparatus 1 via the optical fiber L1, it is input into the input/output port P1 of the optical circulator 11, and then output from the input/output port P2 thereof. The optical signal S1 output from the input/output port P2 is then launched into the EDF 12, so that it is amplified by the predetermined amplification rate. In this process, as the idle light S4 is simultaneously launched into the EDF 12, stimulated emission occurs, and a certain amount of energy is always consumed. Therefore, even if there is a period in which no signal is input before the optical signal S1 is launched into the EDF 12, no excessive energy is stored in the EDF 12, thereby relaxing the above-described overshooting. The optical signal amplified by the EDF 12 is launched as the optical signal S2 via the optical isolator 13 from the optical fiber L2 to the outside of the optical amplification apparatus 1.

As described above, in accordance with the present embodiment, the idle-light LD 16 is contained in the package of the optical amplification apparatus 1, and the idle light S4 is launched into the EDF 12 from a point between the EDF 12 and the optical isolator 13. Therefore, it is possible to omit the wavelength filter 104 which should be provided in the conventional optical amplification apparatus 100 (see FIG. 4). Accordingly, size reduction is possible. In addition, the excited-light LD 14 and the optical isolator 15 are provided in the package of the optical amplification apparatus 1, which is also effective for reducing the size of the optical amplification apparatus 1.

Also in accordance with the present embodiment which employs the optical circulator 11, (i) the optical signal S1 launched through the optical fiber L1 is directed toward the input end of the EDF 12, and (ii) the idle light S4, which is launched from the input end of the EDF 12 via the EDF 12, is directed toward the optical absorption member 18. Therefore, there is no wavelength range (as there is in the conventional optical amplification apparatus 100 (see FIG. 4)) which is blocked by the wavelength filter 104. Accordingly, it is possible to widen the wavelength range which can be used in the relevant apparatus.

Also in accordance with the present embodiment, even when the wavelength of the idle light S4 is identical to that of a channel which belongs to the optical signal S1, no overshooting occurs, and the optical signal S1 can be amplified by a desired amplification rate. Therefore, the degree of freedom in the wavelength selection of the idle light S4 is very high, and it is unnecessary to set the wavelength range of the optical signal S1 to that which does not include the wavelength of the idle light S4. Accordingly, it is possible to widen the wavelength range of the optical signal S1.

FIG. 2 is a block diagram showing the general structure of an optical amplification apparatus 2 as a variation of the embodiment of the present invention. In comparison with the optical amplification apparatus 1 of FIG. 1, the optical amplification apparatus 2 has a distinctive feature to provide an optical isolator 20 (as the input-side isolator of the present invention) instead of the optical circulator 11 and the optical absorption member 18.

The input end of the optical isolator 20 is connected to the optical fiber L1, and the output end thereof is connected to one end (i.e., input end) of the EDF 12, so that the optical signal S1 is transmitted only in the direction from the optical fiber L1 to the input end of the EDF 12. Accordingly, the optical isolator 20 blocks any optical signal directed from the EDF 12 to the optical fiber L1.

In the optical amplification apparatus 1 of FIG. 1, the idle light S4, which passes through the EDF 12, is directed to the optical absorption member 18 by using the optical circulator 11, so as to absorb the idle light S4. In contrast, in the present variation, the idle light S4, which passes through the EDF 12, is directly launched into the optical isolator 20. As described above, the optical isolator 20 blocks light which is directed from the EDF 12 toward the optical fiber L1. Therefore, it is possible to prevent the idle light S4 from being launched into the optical fiber L1. In addition, if reflection of the idle light S4, which is launched into the optical isolator 20, is too small to be ignored, it is also possible to prevent the idle light S4, which is reflected by the optical isolator 20, from being launched from the optical fiber L2 to the outside of the optical amplification apparatus 2.

Also in the optical amplification apparatus 2, the idle-light LD 16 is provided in the package 2 of the optical amplification apparatus 2, and the idle light S4 is launched into the EDF 12 from a point between the EDF 12 and the optical isolator 13. Therefore, also in this structure, it is possible to omit the wavelength filter 104, which is necessary in the conventional optical amplification apparatus 100 (see FIG. 4). Accordingly, size reduction is possible. Also in the present variation, the excited-light LD 14 and the optical isolator 15 are provided in the package of the optical amplification apparatus 2, which is also effective for reducing the size of the optical amplification apparatus 2. In addition, as the wavelength filter 104, which is necessary in the conventional optical amplification apparatus 100, is unnecessary also in the optical amplification apparatus 2, there is no wavelength range which is blocked by the wavelength filter 104. Accordingly, it is possible to widen the wavelength range which can be used in the relevant apparatus.

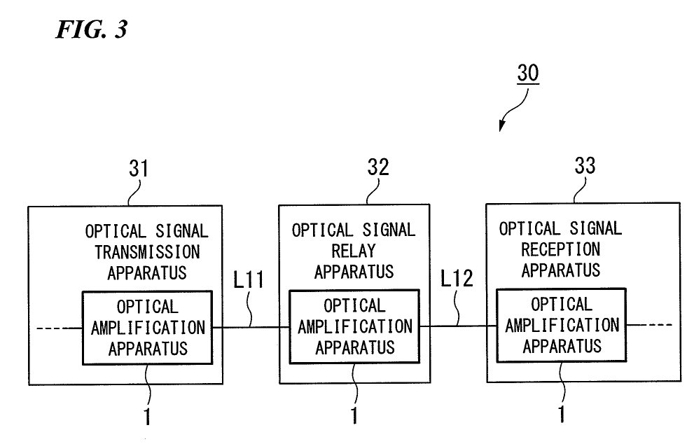

FIG. 3 is a block diagram showing the general structure of an optical communication system 30. As shown in FIG. 3, the optical communication system 30 includes an optical signal transmission apparatus 31, an optical signal relay apparatus 32, and an optical signal reception apparatus 33, each of which functions as an optical communication apparatus. The optical signal transmission apparatus 31 and the optical signal relay apparatus 32 are connected to each other via an optical fiber L11, and the optical signal relay apparatus 32 and the optical signal reception apparatus 33 are connected to each other via an optical fiber L12.

The optical signal transmission apparatus 31, the optical signal relay apparatus 32, and the optical signal reception apparatus 33 each include the above-described optical amplification apparatus 1. The optical signal transmission apparatus 31 amplifies an optical signal by the optical amplification apparatus 1, and transmits the amplified signal to the optical fiber L11. The optical signal relay apparatus 32 amplifies the optical signal, which is transmitted via the optical fiber L11, by using the optical amplification apparatus 1, and performs a relay operation (including switching), so that the optical signal is further transmitted to the optical fiber L12. The optical signal reception apparatus 33 amplifies the optical signal, which is transmitted via the optical fiber L12, by using the optical amplification apparatus 1, and also receives the optical signal.

In accordance with the optical communication system 30 having the above-described structure, in each of the optical communication apparatuses (i.e., the optical signal transmission apparatus 31, the optical signal relay apparatus 32, and the optical signal reception apparatus 33), the optical signal can be amplified without overshooting. Therefore, even when optical bursts or packets are intermittently launched, communication can be performed in preferable conditions. In addition, instead of the optical amplification apparatus 1, the optical signal transmission apparatus 31, the optical signal relay apparatus 32, and the optical signal reception apparatus 33 may each have the above-described optical amplification apparatus 2.

While preferred embodiments of the present invention have been described and illustrated above, it should be understood that these are exemplary embodiments of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

For example, in the above-described embodiment, the optical amplification medium is an EDF. However, the present invention can also be applied to an apparatus which employs an optical amplification medium other than the EDF, for example, another rare-earth-doped optical fiber such as a thulium-doped optical fiber or a praseodymium-doped optical fiber, or any other optical amplification medium.

Also in the above-described embodiment, the excited light S3 is launched into the EDF 12 from the input side thereof, that is, from a point between the optical circulator 11 or the optical isolator 20 and the EDF 12, and the idle light S4 is launched into the EDF 12 from the output side thereof, that is, from a point between the optical isolator 13 and the EDF 12. However, both the excited light S3 and the idle light S4 may be launched from the output side of the EDF 12.

What is claimed is:

1. An optical amplification apparatus comprising:
an optical amplification medium which has an input end and an output end, and amplifies an optical signal by a predetermined amplification rate;
a first light source for launching excited light which excites the optical amplification medium;
an isolator connected to the output end of the optical amplification medium; and
a second light source for launching idle light which has a predetermined wavelength and is launched into the optical amplification medium from a point between the optical amplification medium and the isolator, wherein:
the optical amplification medium, the first light source, the isolator, and the second light source are contained in the package of the optical amplification apparatus.

2. The optical amplification apparatus in accordance with claim 1, further comprising:
an optical absorption member for absorbing the idle light; and
a circulator connected to the input end of the optical amplification medium, wherein the circulator directs the optical signal to the input end of the optical amplification medium, and directs the idle light, which is launched from the input end of the optical amplification medium, to the optical absorption member, wherein:
the optical absorption member and the circulator are also contained in the package.

3. The optical amplification apparatus in accordance with claim 1, further comprising:
an input-side isolator which is connected to the input end of the optical amplification medium, and transmits the optical signal only in the direction toward the input end of the optical amplification medium, wherein:
the input-side isolator is also contained in the package.

4. The optical amplification apparatus in accordance with claim 1, wherein:
the second light source launches light, which has a wavelength belonging to the wavelength range of the optical signal, as the idle light.

5. The optical amplification apparatus in accordance with claim 1, wherein:
the wavelength of the idle light launched from the second light source is variable.

6. The optical amplification apparatus in accordance with claim 1, wherein:
the optical amplification medium is an erbium-doped optical fiber.

7. An optical communication apparatus for intermittently transmitting, receiving, or relaying an optical signal, comprising:
the optical amplification apparatus in accordance with claim 1, which amplifies the optical signal.
